(19) United States
(12) Patent Application Publication
(10) Pub. No.: US 2016/0259209 A1
(43) Pub. Date: Sep. 8, 2016

(54) BACKLIGHT UNIT

(71) Applicant: DENSO CORPORATION, Kariya-city, Aichi (JP)

(72) Inventor: Hideki ITO, Kariya-city (JP)

(21) Appl. No.: 15/033,156

(22) PCT Filed: Oct. 30, 2014
(86) PCT No.: PCT/JP2014/005487

§ 371 Date: Apr. 29, 2016

(30) Foreign Application Priority Data
Nov. 1, 2013 (JP) 2013-228415

(51) Int. Cl. G02F 1/1335

(52) U.S. Cl. CPC G02F 1/133611; G02F 1/133603; G02F 1/133606; G02F 1/133605

(57) ABSTRACT

A backlight unit includes an anisotropic sheet disposed between a rectangular display panel portion and a light source disposed directly behind the rectangular display panel portion. The anisotropic sheet is a sheet to transmit and diffuse an emitted light of the light source toward the rectangular display panel portion, and has a structure that makes the emitted light more widely diffuse in a direction along a long side of a display surface of the rectangular display panel portion than in a direction along a short side of the display surface of the rectangular display panel portion. The long side and the short side of the display surface are different lengths.

### CROSS REFERENCE TO RELATED APPLICATION

This application is based on Japanese Patent Applications No. 2013-228415 filed on Nov. 1, 2013, the disclosure of which is incorporated herein by reference.

### TECHNICAL FIELD

The present disclosure relates to a backlight unit disposed on a back side of a liquid crystal panel or the like.

### BACKGROUND ART

Conventionally, a liquid crystal display apparatus including a backlight unit and using an LED as a light source is popular. There are two kinds of this backlight unit. A first is a direct type in which an LED is disposed directly behind a liquid crystal panel. A second is an edge type in which an LED is disposed on an edge side of a liquid crystal panel and a light guide plate guides the light to the liquid crystal panel.

In the edge type backlight unit, it not required that the LED be disposed directly behind the liquid crystal panel. The edge type backlight unit is frequently used for products that require liquid crystal apparatuses to be thinned (e.g., smartphone, tablet terminal and the like).

On the other hand, an advantage of the direct type backlight unit is that LEDs can be disposed for respective unit areas of the liquid crystal panel and each LED can be individually driven and controlled (i.e., area control is possible). Thus, the direct type backlight unit is frequently used for products that need high quality images for liquid crystal apparatuses.

In any types of backlight unit, because the LED is a light source with strong directivity, it is required to homogenously diffuse the light that is emitted from the LED to the liquid crystal panel, in order to homogenously illuminate the whole liquid crystal panel.

In this relation, Patent Literature 1 discloses a direct type backlight unit. In this direct type backlight unit, a reflecting plate having a plurality of light penetrating holes is disposed between a LED and a liquid crystal panel. A reflecting member having an opposed surface opposed to the reflection plate on a LED side is disposed. Opening areas of the plurality of light penetrating holes increase toward each vertex of the reflecting plate. Specifically, in the reflecting plate, a light passing amount increases with increasing distance from a center corresponding to the position of the LED, so that the directivity of the LED is relaxed. Thereby the irradiation light to the liquid crystal panel as a whole is homogenized.

### PRIOR ART LITERATURES

### Patent Literature

Patent Literature 1: JP-2012-174372A

### SUMMARY OF INVENTION

The inventors of the present application have found out the following concerning a backlight unit.

A conventional direct type backlight unit is directed to a liquid crystal display apparatus for a TV or the like. Thus, each unit area of the liquid crystal panel directly behind which a LED is disposed can be partitioned into a square and the light can be homogenously irradiated to the square unit area. However, the conventional direct type backlight unit cannot meet unit areas of such a shape as, for example, a rectangle or the like having a short side and a long side.

Specifically, in a conventional direct type backlight unit, the emitted light from the LED isotropically diffuses by the reflecting plate. Accordingly, there is a concern that the brightness at the short side of the display surface remarkably decreases.

In view of the foregoing, it is an object of the present disclosure to provide a backlight unit that can appropriately homogenize light radiation to a display panel portion having a rectangular shape, two sides of which are different lengths and perpendicular to each other in a display surface.

In the present disclosure, a light source is disposed directly behind a display panel portion. A backlight unit comprises an anisotropic sheet disposed between the light source and the display panel portion. The display panel portion may refer to a unit area of a liquid crystal panel as in a conventional structure, or may refer to a liquid crystal panel as a whole as long as its display surface is smaller than that of a TV or the like.

The anisotropic sheet is a sheet which transmits and diffuses an emitted light of the light source toward the display panel portion. The anisotropic sheet has a structure that makes the emitted light more widely diffuse in a direction along a long side of the display surface than in a direction along a short side of the display surface. Specifically, because this anisotropic sheet is disposed, reduction of brightness of the light around the short side of the display surface can be prevented when the light is irradiated to the display panel portion having, for example, a rectangular shape. This cannot be achieved in the conventional art.

Therefore, in the present disclosure, it becomes possible to homogenous the light irradiation to an equiangular quadrilateral display surface in which two sides are different lengths and perpendicular to each other.

In the present disclosure, the backlight unit may further comprise a reflecting plate and a reflecting sheet. In this case, all light penetrating holes having a same size may be formed in the reflecting plate. The light penetrating holes per unit area may increase toward each vertex of the reflecting plate

In this structure, at the stage of, for example, backlight unit development, only adjusting positions of light penetrating holes and the number of light penetrating holes without changing the size of the light penetrating hole makes it possible to repeatedly perform tests regarding homogenous light irradiation to the display panel portion. Therefore, it becomes possible to contribute to backlight unit development tests.

### BRIEF DESCRIPTION OF DRAWINGS

FIG. 1 is an exploded view illustrating an outline structure of a liquid crystal display apparatus including a backlight unit of an embodiment.

FIG. 2(a) is a front view illustrating a structure of an in-vehicle meter apparatus provided with a liquid crystal display apparatus and FIG. 2(b) is a sectional view illustrating a structure of an in-vehicle meter apparatus provided with a liquid crystal display apparatus.

FIG. 3 is a perspective view illustrating a structure of an anisotropic sheet.

FIG. 4(a) is a front view illustrating a structure of a reflecting plate and

FIG. 4(b) is a sectional view taken along line IV-IV(b) in FIG. 4(a).

FIG. 5 is an explanatory diagram illustrating how a reflecting plate and a reflecting sheep act on an emitted light from a light source.

FIG. 6 is a first diagram showing a radiation light to a liquid crystal panel.

FIG. 7(a) is a second diagram showing a radiation light to a liquid crystal panel and FIG. 7(b) is a sectional view illustrating a structure of an in-vehicle meter apparatus provided with a liquid crystal display apparatus including an edge type backlight unit.

FIG. 8 is a line drawing of FIG. 6.

FIG. 9 is a line drawing of FIG. 7(a).

### EMBODIMENTS FOR CARRYING OUT INVENTION

A liquid crystal display apparatus 1 will be described with reference to the drawings. The liquid crystal display apparatus 1 is an embodiment of an apparatus including a backlight unit of the present disclosure.

Embodiments of the present disclosure are not limited to those illustrated below. A mode in which part of the below embodiment is omitted to extents that can a problem is also an embodiment of the present embodiment. Any modes conceivable to extents that do not go beyond sprit and scope of the present disclosure are also embodiments of the present disclosure.

<Overall Structure>

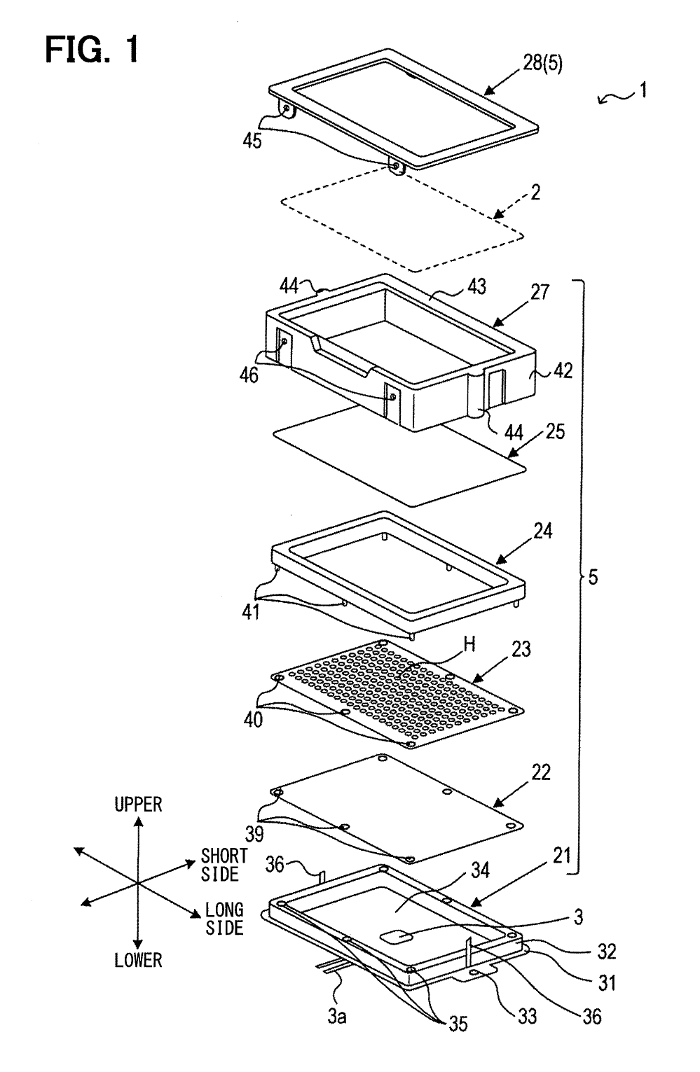

As shown in FIG. 1, the liquid crystal display apparatus 1 includes a liquid crystal panel 2 corresponding to a display panel portion, a LED light source 3 corresponding to a light source, and a backlight unit 5.

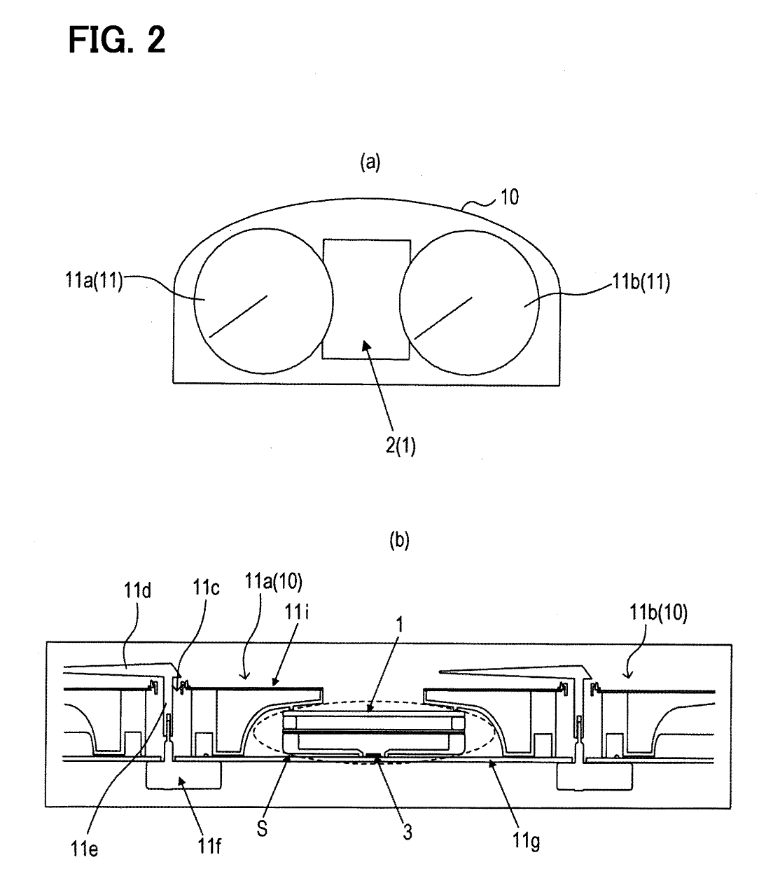

As shown in FIG. 2(a), the liquid crystal display apparatus 1 of the present embodiment is arranged together with instruments such as a speedometer 11a, a tachometer 11b and the like in a meter apparatus mounted in a vehicle. The liquid crystal panel 2 can display, for example, shift lever position, remaining fuel, engine coolant temperature, direction indicator, head lamp direction, various warning lamps and the like.

Specifically, because the liquid crystal panel 2 may suffice as long as these kinds of information can be displayed, needs of high quality images for the liquid crystal panel 2 are low as compared with TV or the like. Additionally, a relatively small size of a display surface of the liquid crystal panel 2 may suffice. However, because it may be preferable to ensure a display area as large as possible in a limited space of the meter apparatus 10 except the speedometer 11a and the tachometer 11b, the used liquid crystal panel 2 has an equiangular quadrilateral display surface in which two sides are perpendicular each other and different lengths (i.e., there are a short side and a long side), such as rectangle.

As shown in FIG. 2(b), the speedometer 11a and the tachometer 11b in the meter apparatus 10 include an opening part 11c disposed at a center of a dial plate, a needle 11d for pointing to a state value such as vehicle speed, engine revolution or the like, a dial plate 11i, and a motor 11f. The motor 11f supports an extension part 11e extending in a lower direction from one end of the needle 11d through the opening part 11c and rotates the other end (tip) of the needle 11d in a circumferential direction of the dial plate. Specifically, in the meter apparatus 10, a relatively large internal space S is ensured according to the lengths of parts including the extension part 11e of the needle 11d and the shaft of the motor 11f. Therefore, needs of thinning of the liquid crystal display apparatus 1 is smaller than a smartphone, a tablet terminal and the like.

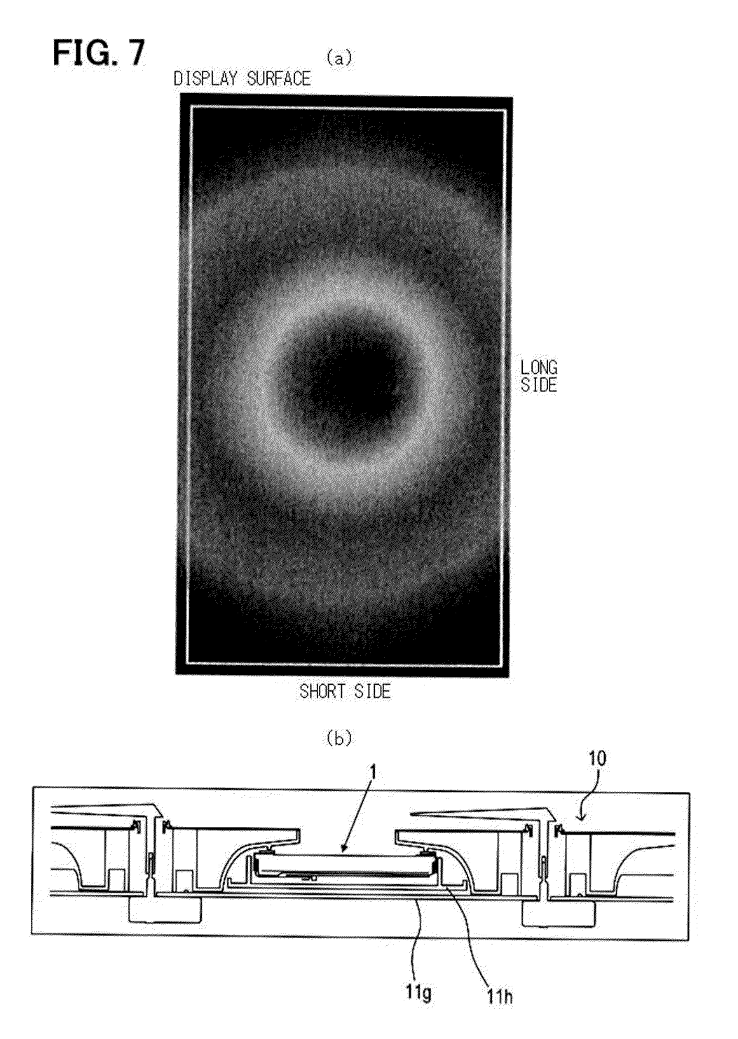

An employable backlight unit 5 may be an edge type one because the needs of high quality images for the liquid crystal display apparatus 1 are relatively low as described below. However, when the edge type one is employed, it is required to add a fixation plate 11h between the meter apparatus 10 and a board 11g to fix the liquid crystal display apparatus 1 to the board 11g, as shown in FIG. 7(b).

In the liquid crystal display apparatus 1 of the present embodiment, a direct-type backlight unit 5 is employed. Thus, the liquid crystal display apparatus 1 can be directly fixed to the board 11g of the meter apparatus 10 and the cost becomes low due to un-installation of the fixation plate 11h (see FIG. 7(b)). Circuit parts (e.g., including a microcomputer or the like) for not only controlling the instruments 11 but also controlling the drive of the LED light source 3 and controlling images of the liquid crystal panel 2 are arranged to the board 11g of the meter apparatus 10.

The LED light source 3 is a single LED (Light Emitting Diode) chip. The LED chip is a light emitting element for generating while light. The LED light source 3 includes a terminal 3a (see FIG. 1) arranged to the board 11g of the meter apparatus 10 and is electrically connected to the circuit parts (not shown) of the board 11g via this terminal 3a. The LED light source 3 emits the light when a drive current is supplied to the terminal 3a on the board 11g.

In the liquid crystal display apparatus 1 of the present embodiment, the liquid crystal panel 2 can be partitioned into multiple unit areas and a signal LED light source 3 can be arranged for each unit area. However, as described above, because the needs of high quality images for the liquid crystal display apparatus 1 are small, the single LED light source 3 is disposed behind the whole liquid crystal panel 2. Because this can reduce the number of parts and the area control become unnecessary, the low cost can be achieved.

<Backlight Unit Structure>

Next, a structure of the backlight unit 5 will be described.

As shown in FIG. 1, the backlight unit 5 includes a base 21, an anisotropic sheet 22, a reflecting plate 23, a spacer 24, a diffusion plate 25, a case 27, and an opening plate 28. These parts 21 to 28 of the backlight unit 5 are assembled, so that these parts are parallel to the display surface of the liquid crystal panel 2. These parts are shaped to correspond to a shape of the liquid crystal panel 2. In particular, each of the anisotropic sheet 22, the reflecting plate 23 and the diffusion plate 25 is a plate-shaped member that has substantially the same shape and the same surface area as the display surface of the liquid crystal panel 2.

The base 21 includes a plate-shaped installation part 31 installed to the board 11g of the meter apparatus 10 and a frame-shaped mounting part 32 to which sides portions of the anisotropic sheet 22 are mounted. Specifically, a screw hole 33 is provided at a center of a short side portion of a bottom surface 32 of the installation part 31. Through the screw hole 33, the base 21 is screwed to the board 11g of the meter apparatus 10.

The LED light source 3 is fixed to a center of an upper surface of the installation part 31. The terminal 3a of the LED light source 3 is bent from the lower surface of the installation part 31 toward a lateral side, and protrudes from a long side of the installation part 31.

The reflecting sheet is laid on a portion of the upper surface of the instillation part 31. This portion is surrounded by the mounting part 32. The reflecting sheet 34 is a film-shaped member that has substantially the same shape and the same surface area as the anisotropic sheet 22, the reflecting plate 23, the diffusion plate 25 and the liquid crystal panel 2 have. The reflecting sheet 34 has an opposed surface which is opposed to the reflecting plate 23. Toward the reflecting plate 23, the reflecting sheet 34 reflects, without transmitting, the light that is emitted from the LED light source 3 and reflected at the reflecting plate 23.

The mounting part 32 is made of, for example, a resin material having a light reflecting property, and acts as a member surrounding the LED light source 3 to prohibit the emitted light of the LED light source 3 from leaking out in a lateral direction. The upper surface of the mounting part 32 has recessed portions 35 at each vertex and a center of each longer side, and has protrusion portions 36 at centers of short sides. The protrusion portions 36 protrude from an outer surface in the upper direction.

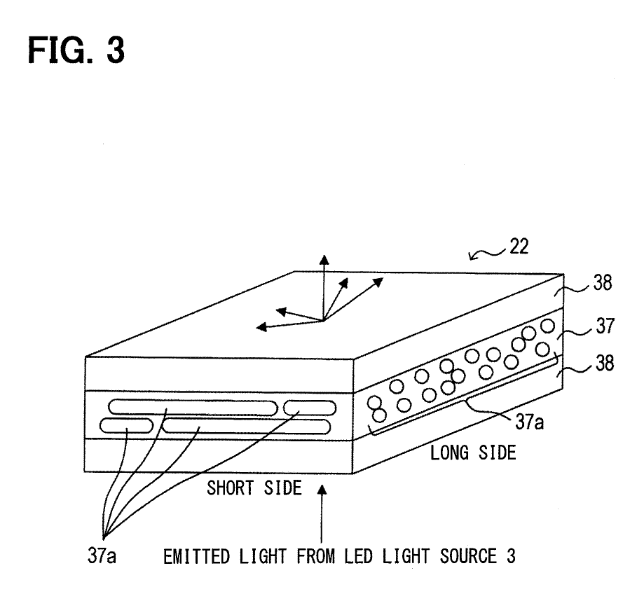

The anisotropic sheet 22 is disposed between the LED light source 3 and the liquid crystal panel 2, and as shown in FIG. 3, includes a known film-shaped diffusion structure body 37 with a particulate structure and film-shaped transmission layers 38. The diffusion structure body 37 widely diffuses the emitted light of the LED light source 3 in a direction along the long side of the anisotropic sheet 22 than in a direction along the short side of the anisotropic sheet 22 (consequently the display surface of the liquid crystal panel 2). The transmission layers 38 are stacked on both of the upper surface and the lower surface of the structure body 37. Specifically, multiple cylindrical diffusion particles 37a for diffusing light are closely arranged in, so that their radial directions match the long side of the anisotropic sheet 22 and their axis directions match the short side of the anisotropic sheet 22. The diffusion structure body 37 is not limited to having particulate structure but may be a known structure body, which has a surface concave convex structure to provide diffusion light anisotropy.

The anisotropic sheet 22 has holes 39 at positions corresponding to the recessed portions 35 of the mounting part 32, respectively.

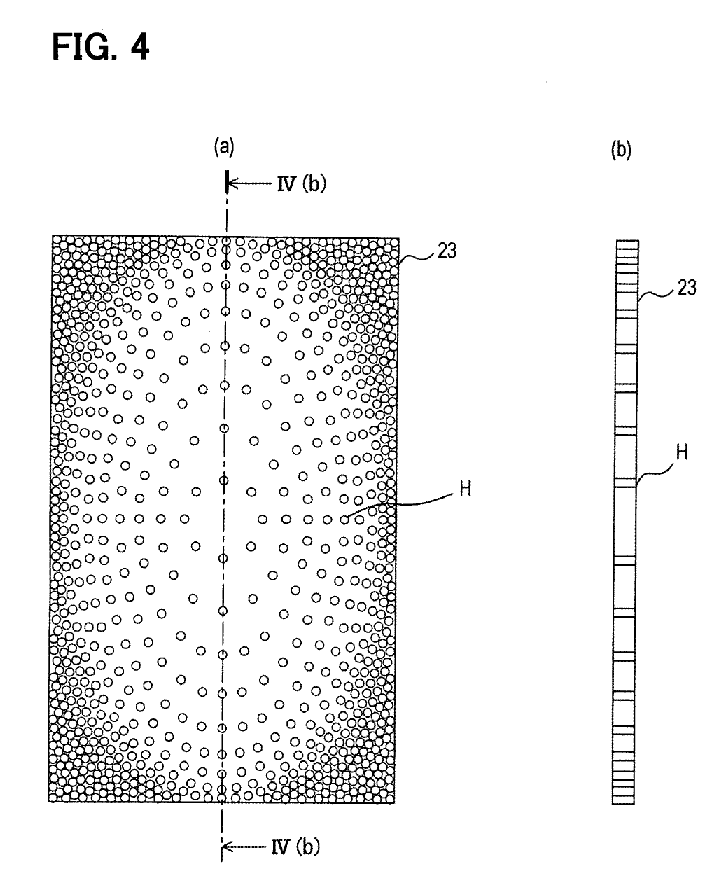

The reflecting plate 23 is disposed between the LED light source 3 and the liquid crystal panel 2 and is a flat plate made of a material (e.g., made of aluminum) having a light reflecting property and a light nontransparent property like the reflecting sheet 34 of the installation part 31. As shown FIG. 4(a) and (b), the reflecting plate 23 has multiple light penetrating holes H for passing light. The light penetrating holes H are arranged radially from the center toward each vertex. The multiple light penetrating holes H have the same shape and size and are formed so that the number of light penetrating holes H per unit area increases toward the each vertex of the reflecting plate 23.

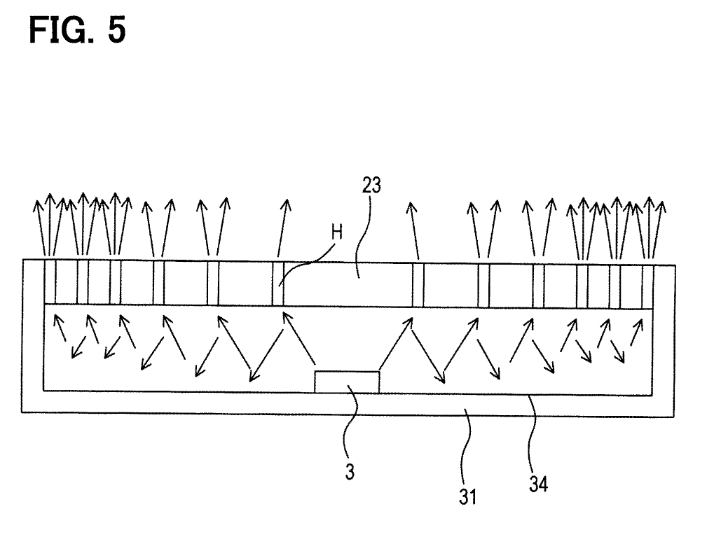

Specifically, as shown in FIG. 5, part of the light emitted from the LED light source 3 directly passes through the light penetrating holes H of the reflecting plate 23 and are radiated in the upper direction. Another part of the light emitted from the LED light source 3 is reflected at the reflecting plate 23 and incident on the reflecting sheet 34 of the installation part 31 opposed to the reflecting plate 23. The light reflected at the reflecting plate 23 is further reflected at the reflecting sheet 34, and due to this reflection, travels in a direction away from the center of the reflecting plate 23 and goes again to the reflecting plate 23. Part of the light reflected at the reflecting sheet 34 passes through the light penetrating holes H of the reflecting plate 23 and is radiated in the upper direction. By repeating this light behavior, the light passing through the light penetrating holes H of the reflecting plate 23 is incident on the reflecting plate 23 located on an upper side.

Because the number of light penetrating holes H per unit area in the reflecting plate 23 increases toward the vertex of the reflecting plate 23 as described above, a light passing amount in the reflecting plate 23 increases with increasing distance from the center corresponding to the position of the LED light source 3. This relaxes the directivity of the LED light source 3 and provides homogenous light radiation to the liquid crystal panel 2 as a whole.

The reflecting plate 23 has holes 40 at positions corresponding to the holes 39 of the anisotropic sheet 22 (consequently the recessed portions 35 of the mounting part 32).

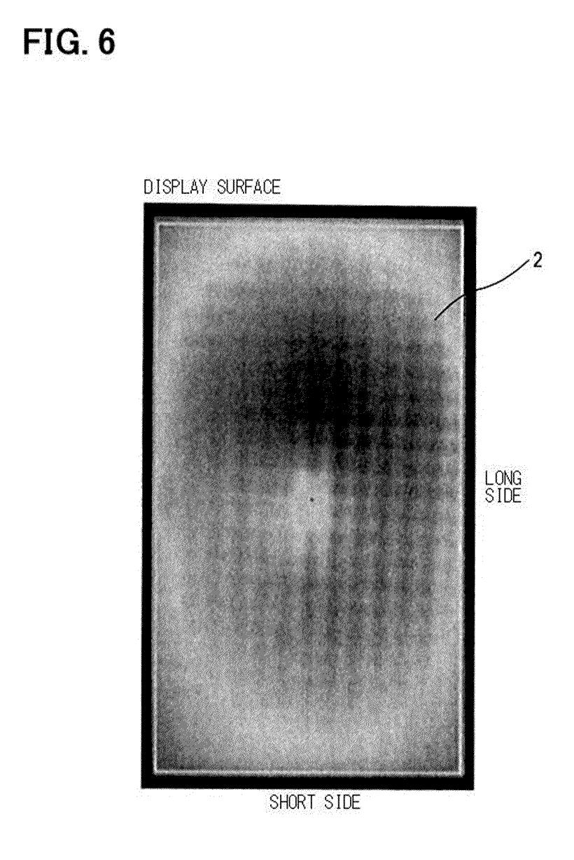

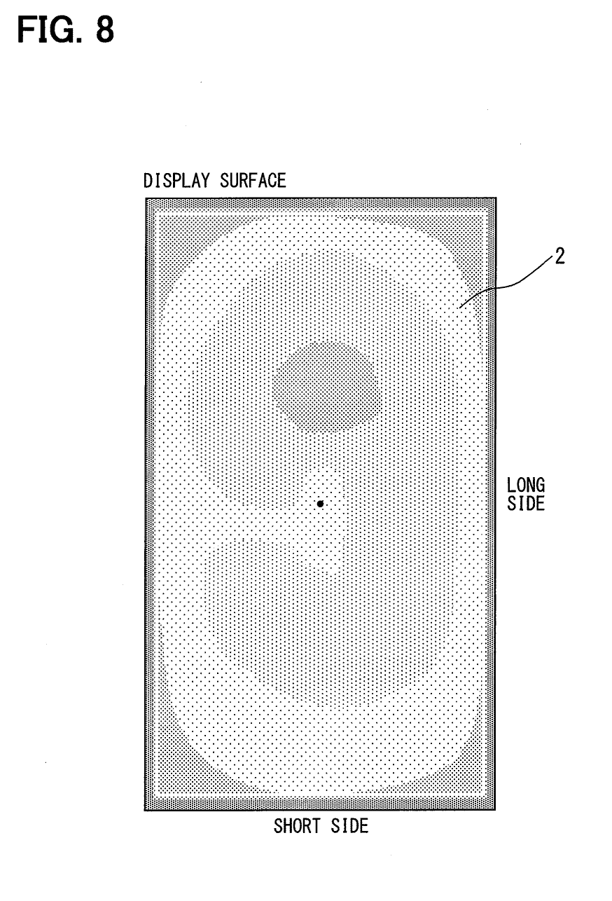

In the present embodiment, the anisotropic sheet 22 is disposed between the LED light source 3 and the reflecting plate 23. Alternatively, the reflecting plate 23 may be disposed between the LED light source 3 and the anisotropic sheet 22. In any of the arrangements, the homogenous light radiation to the liquid crystal panel 2 as illustrated in FIG. 6 and FIG. 8 can be achieved by adjusting the positions and the number of light penetrating holes H in the reflecting plate 23 in advance.

The spacer 24 is a frame-shaped member and includes protrusion portions 41 engaged with the recessed portions 35 of the mounting part 32, respectively. In a state the protrusion portions 41 are inserted into the holes 39 of the anisotropic sheet 22 and the holes 40 of the reflecting plate 23, the protrusion portions 41 are jointed to the recessed portions 35 of the mounting part 32, thereby fixing the anisotropic sheet 22 and the reflecting plate 23 to the base 21.

The diffusion plate 25 is disposed between the reflecting plate 23 and the liquid crystal panel 2. The light radiated in the upper direction from the LED light source 3 through the anisotropic sheet 22 and the reflecting plate 23 are incident on the diffusion plate 25 and are diffused by the diffusion plate 25 toward the liquid crystal panel 2. The diffusion plate 25 is for reducing shadow resulting from light blocking by other portions of the reflecting plate 23 than the light penetrating holes H, by isotropic ally diffusing the light that has passed through the light penetrating holes H of the reflecting plate 23. The number of diffusion plates 25 disposed is not limited to one but two or more (e.g., three).

The case 27 includes a frame part 42, and a restriction part 43, and a joint part 44. The frame part 42 has a frame shape surrounding the spacer 24. The restriction part 43 restricts an upper direction movement of the spacer 24. The joint part 44 is jointed to the protrusion portions 36 of the mounting part 32.

Specifically, in a state where the anisotropic sheet 22 and the reflecting plate 23 are fixed to the base 21 by the spacer 24 and the diffusion plate 25 is mounted to the upper surface of the spacer 24, the lower surface of the restriction part 43 is abutted to the diffusion plate 25 and the joint part 44 disposed at the center of the short side of the frame part 42 is jointed to the protrusion portion 36 of the mounting part 32, and thereby the diffusion plate 25, the spacer 24, the reflecting plate 23 and the anisotropic sheet 22 are fixed to the base 21.

The opening plate 28 is a frame-shaped member having a shape and a size corresponding to the upper surface of the restriction part 43 of the case 27.

The opening plate 28 has screw holes 45 at multiple sites of the long side of the opening plate 28. The screw holes 45 extend in the lower direction. Specifically, in a state where the liquid crystal panel 2 is mounted to the upper surface of the restriction part 43 of the case 27, the screw holes 45 and screw holes 46 disposed on an outer side of the long side of the frame part 42 of the case 27 are fixed by screwing, and thereby the liquid crystal panel 2 is fixed to the case 27.

<Advantages>

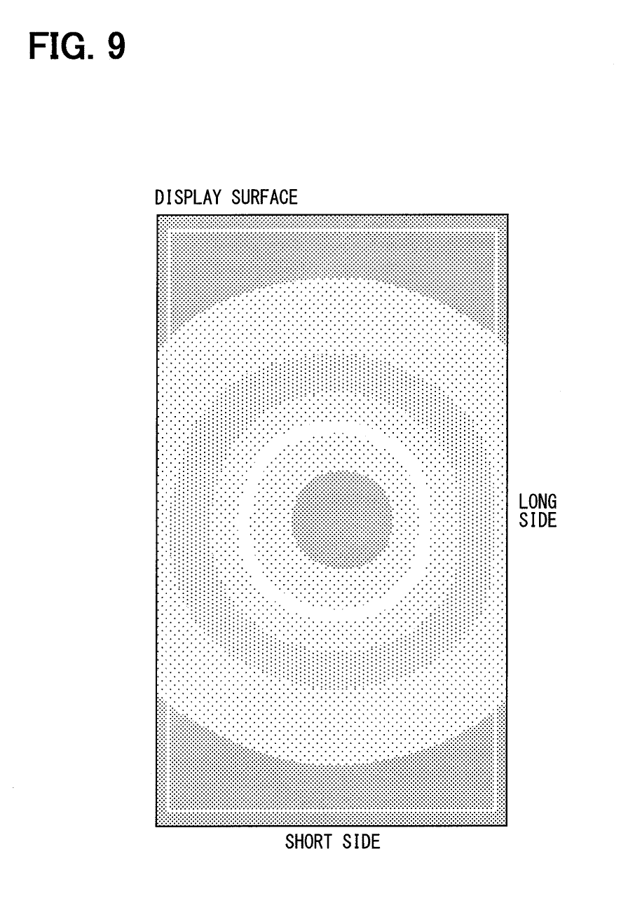

As described above, in the backlight unit 5, the anisotropic sheet 22 is disposed between the LED light source 3 and the liquid crystal panel 2, and has a structure that makes the light, which is emitted from the LED, more widely diffuse in a direction along the long side of the display surface of the liquid crystal panel 2 than in a direction along the short side of the display surface. Therefore, the reduction of the brightness around the short side of the display surface of the liquid crystal panel 2 can be prevented. Specifically, in some direct-type backlight units, an emitted light from an LED is isotropically diffused by a reflecting plate, brightness around a short side of a display surface is remarkably reduced, as shown in FIG. 7(a) and FIG. 9. By contrast, in the backlight unit 5 of the present embodiment, because of the presence of the anisotropic sheet 22, the reduction of the brightness around the short side of the display surface can be prevented, as shown in FIG. 6 and FIG. 8.

Therefore, the backlight unit 5 can advantageously homogenize the light radiation to the rectangular liquid crystal panel 2, in which two sides of the display surface perpendicular to each other have different lengths.

Furthermore, in the backlight unit 5, the reflecting plate 23 is disposed between the LED light source 3 and the liquid crystal panel 2 and has multiple light penetrating holes H having the same shape and size. The number of multiple light penetrating holes per unit area increases toward each vertex of the reflecting plate. Therefore, the light reflection is repeated between the reflecting plate 23 and the reflecting sheet 34 opposed to the reflecting plate 23 on a LED light source 3 side.

Moreover, in the backlight unit 5, the diffusion plate 25 for isotropically diffusing the light is disposed between the reflecting plate 23 and the liquid crystal panel 2. Therefore, the shadow, which may result from the light blocking by other portions of the reflecting plate 23 than the light penetrating holes H, can be reduced. The homogenous light irradiation to the whole liquid crystal panel 2 can be well achieved.

<Other embodiments>

Although embodiments of the present disclosure have been illustrated above, embodiments of the present disclosure are not limited to those illustrated above. Various embodiments are possible within the spirit and scope of the present disclosure.

For example, in the backlight unit 5 of the above embodiment, the liquid crystal panel 2 is used for the in-vehicle meter panel. However, this is not limiting. The liquid crystal panel 2 is used for, for example, TV. In this case, the LED light sources 3 may be arranged for respective each unit areas of the liquid crystal panel 2. On assumption that respective LED light sources 3 are individually driven and controlled as the area control, the backlight unit 5 may be provided for each unit area and each LED light source 3.

In the backlight unit 5 of the above embodiment, the multiple light penetrating holes H having the same shape and size are formed in the reflecting plate 23 so that the number of light penetrating holes H per unit area increases toward each vertex. However, this is not limiting. For example, as in a conventional art, light penetrating holes H may be formed so that their opening areas increase toward each vertex.

Moreover, in the backlight unit 5 of the above embodiment, the light irradiated from the LED light source 3 toward the liquid crystal panel 2 is anisotropic ally diffused by the anisotropic sheet 22 and the reflecting plate 23. However, this is not limiting. It may be sufficient for the backlight unit 5 to include at least the anisotropic sheet 22.

Although embodiments and structures of the present disclosure have been illustrated above, embodiments and structures of the present disclosure are limited to those illustrated above. Embodiments and structures obtained by appropriately combining technical elements disclosed in different embodiments and structures are also within embodiments and structures of the present disclosure.

What is claimed is:

1. A backlight unit for a rectangular display panel portion and a light source disposed directly behind the display panel portion, wherein two sides of a display surface of the display panel portion are perpendicular to each other and have different lengths,
the backlight unit comprising:
an anisotropic sheet that is disposed between the rectangular display panel portion and the light source, is a sheet to transmit and diffuse an emitted light of the light source toward the rectangular display panel portion, and has a structure that makes the emitted light more widely diffuse in a direction along a long side of the display surface of the rectangular display panel portion than in a direction along a short side of the display surface of the rectangular display panel portion.

2. The backlight unit according to claim 1, further comprising
a reflecting plate that is disposed between the light source and the rectangular display panel portion and is a plate to reflect, without transmitting, the emitted light of the light source toward the light source, wherein the reflecting plate has a plurality of light penetrating holes which penetrate from a light source side to a rectangular display panel portion side; and
a reflecting sheet that, on a light source side, has an opposed surface which opposed to the reflecting plate, and is a sheet to reflect, without transmitting, the emitted light reflected by the reflecting plate toward the reflecting plate
wherein
all the plurality of light penetrating holes have a same size, and
the number of light penetrating holes per unit area in the reflecting plate increases toward each vertex of the reflecting plate.

3. The backlight unit according to claim 1, wherein
the rectangular display panel portion is used in an in-vehicle meter.
